(19) United States
(12) Patent Application Publication
(10) Pub. No.: US 2024/0066631 A1
(43) Pub. Date: Feb. 29, 2024

(54) LASER PROCESSING APPARATUS

(71) Applicant: SEIKO EPSON CORPORATION, Tokyo (JP)

(72) Inventor: Hiroki NISHIOKA, Suwa-shi (JP)

(73) Assignee: SEIKO EPSON CORPORATION, Tokyo (JP)

(21) Appl. No.: 18/239,385

(22) Filed: Aug. 29, 2023

(30) Foreign Application Priority Data
Aug. 30, 2022 (JP) 2022-136587

(51) Int. Cl. B23K 26/08

(52) U.S. Cl. CPC B23K 26/0876

(57) ABSTRACT

A laser processing apparatus includes a stage, a laser element, a light receiving element configured to receive the laser light from the laser element, a moving mechanism configured to change a relative position of the laser element and the stage and a relative position of the laser element and the light receiving element, and a control unit. The control unit performs a first process of controlling the laser element and the moving mechanism to irradiate the light receiving element with laser light in a state where the laser element and the light receiving element face each other, and a second process of controlling the laser element and the moving mechanism to irradiate a workpiece with laser light based on a detection value of the light receiving element in a state where the laser element and the workpiece face each other.

The present application is based on, and claims priority from JP Application Serial Number 2022-136587, filed Aug. 30, 2022, the disclosure of which is hereby incorporated by reference herein in its entirety.

### BACKGROUND

### 1. Technical Field

The present disclosure relates to a laser processing apparatus.

### 2. Related Art

Laser processing apparatuses that process workpieces through laser irradiation are known. Such laser processing apparatuses are known as metal 3D printers using a laser melting method (Selective Leaser Melting: SLM), for example.

For example, JP-A-2021-154714 discloses a three-dimensional printer apparatus including a printer head including a light-emitting element array where light-emitting elements are arranged, a liquid tank that houses photosetting liquid that is cured with light emitted from the printer head, and a stage unit where a mold formed by being cured with light adheres.

With the above-mentioned laser processing apparatus for processing workpieces, the characteristics of the light-emitting element are shifted from the designed value in some situation when the laser processing is repeatedly performed, for example. The workpiece cannot be accurately processed if it is processed in the state where the characteristics of the light-emitting element are shifted from the designed value.

### SUMMARY

An aspect of a laser processing apparatus according to the present disclosure includes a stage on which a workpiece is placed, a laser element configured to emit laser light, a light receiving element configured to receive the laser light from the laser element, a moving mechanism configured to change a relative position of the laser element and the stage and a relative position of the laser element and the light receiving element, and a control unit configured to control the laser element and the moving mechanism. The control unit performs a first process of controlling the laser element and the moving mechanism to irradiate the light receiving element with laser light in a state where the laser element and the light receiving element face each other, and a second process of controlling the laser element and the moving mechanism to irradiate the workpiece with laser light based on a detection value of the light receiving element in a state where the laser element and the workpiece face each other.

### BRIEF DESCRIPTION OF THE DRAWINGS

FIG. 1 is a perspective view schematically illustrating a laser processing apparatus according to the embodiment.

FIG. 2 is a perspective view schematically illustrating the laser processing apparatus according to the embodiment.

FIG. 3 is a bottom view schematically illustrating a processing head of the laser processing apparatus according to the embodiment.

FIG. 4 is a sectional view schematically illustrating the laser processing apparatus according to the embodiment.

FIG. 5 is a sectional view schematically illustrating the laser processing apparatus according to the embodiment.

FIG. 6 is a sectional view schematically illustrating the laser processing apparatus according to the embodiment.

FIG. 7 is a sectional view schematically illustrating the laser processing apparatus according to the embodiment.

FIG. 8 is a flowchart for describing a process of a control unit of the laser processing apparatus according to the embodiment.

FIG. 9 is a graph illustrating a relationship between the time and the light output at a laser element of the laser processing apparatus according to the embodiment.

FIG. 10 is a graph illustrating a relationship between the injected current and the light output at the laser element of the laser processing apparatus according to the embodiment.

FIG. 11 is a graph illustrating a relationship between the injected current and the light output at the laser element of the laser processing apparatus according to the embodiment.

FIG. 12 is a sectional view schematically illustrating a laser processing apparatus according to a first modification of the embodiment.

FIG. 13 is a perspective view schematically illustrating a laser processing apparatus according to a second modification of the embodiment.

FIG. 14 is a perspective view schematically illustrating the laser processing apparatus according to the second modification of the embodiment.

### DESCRIPTION OF EMBODIMENTS

Preferred embodiments of the present disclosure are described in detail below with reference to the accompanying drawings. Note that the embodiments described below do not unduly limit the contents of the present disclosure described in the claims. In addition, all of the configurations described below are not necessarily essential to the present disclosure.

1. Laser Processing Apparatus

1.1. Configuration

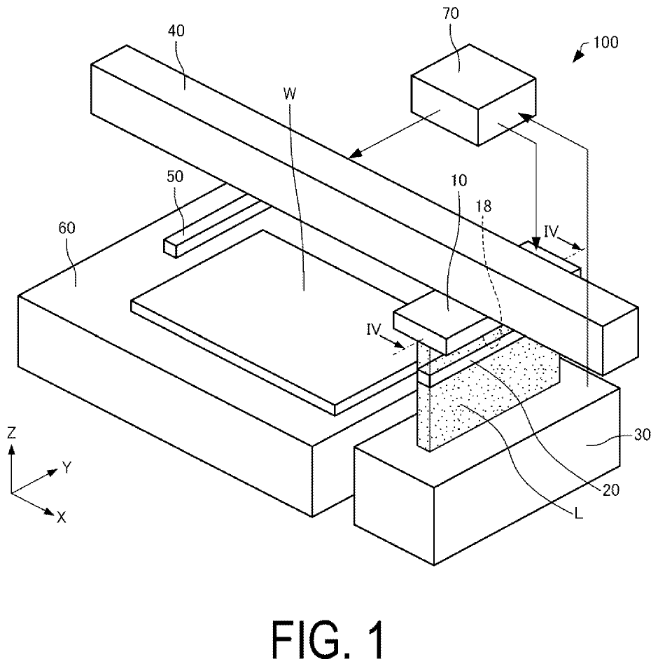

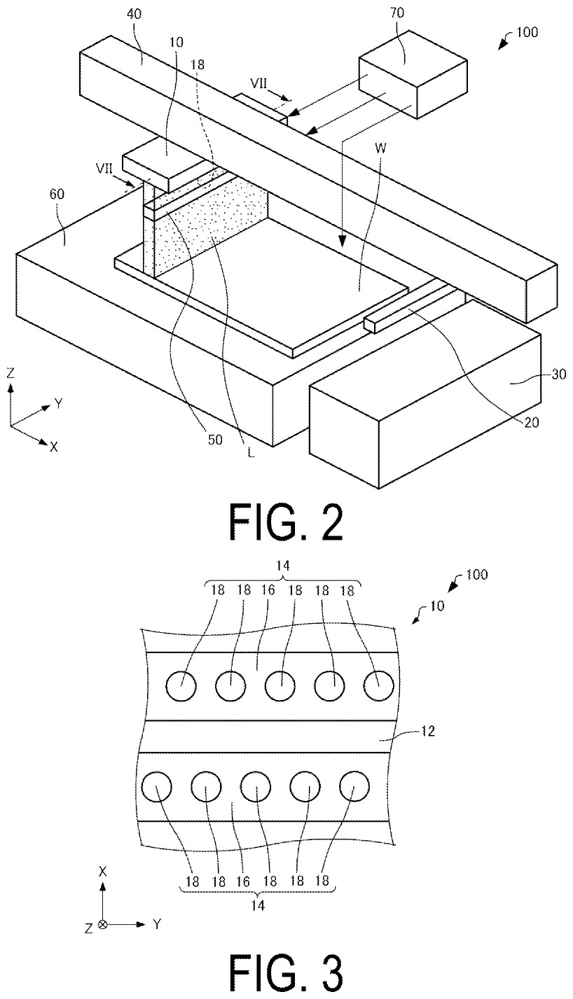

First, a laser processing apparatus according to the embodiment is described with reference to the drawings. FIGS. 1 and 2 are perspective views schematically illustrating a laser processing apparatus 100 according to the embodiment.

Note that FIGS. 1 and 2 illustrate three axes orthogonal to each other, namely, the X axis, the Y axis, and the Z axis. The X-axis direction and the Y-axis direction are horizontal directions, for example. The Z-axis direction is a vertical direction, for example.

As illustrated in FIGS. 1 and 2, the laser processing apparatus 100 includes a processing head 10, a first optical element 20, a light receiving element 30, a moving mechanism 40, a second optical element 50, a stage 60, and a control unit 70. Note that FIG. 1 illustrates a state where the processing head 10 and the light receiving element 30 face each other. FIG. 2 illustrates a state where the processing head 10 and workpiece W face each other. The laser processing apparatus 100 is a metal 3D printer using a SLM, for example.

The processing head 10 emits laser light L. In the example illustrated in the drawing, the processing head 10 emits the laser light L in the −Z-axis direction. The processing head 10 processes a workpiece W with the laser light L. Here, FIG. 3 is a bottom view schematically illustrating the processing head 10.

As illustrated in FIG. 3, the processing head 10 includes a first substrate 12 and a laser element array 14, for example. The first substrate 12 supports the laser element array 14. The material of the first substrate 12 is not limited.

The laser element array 14 is provided in the first substrate 12. In the example illustrated in the drawing, the laser element array 14 has a shape extended in the Y-axis direction. A plurality of the laser element arrays 14 is provided, for example. The number of the laser element arrays 14 is not limited. In the example illustrated in the drawing, two laser element arrays 14 are provided. The two laser element arrays 14 are arranged in the X-axis direction.

The laser element array 14 includes a second substrate 16 and a laser element 18, for example. The second substrate 16 is provided in the first substrate 12. The material of the second substrate 16 is not limited.

The laser element 18 is provided in the second substrate 16. The laser element 18 emits the laser light L. In the example illustrated in the drawing, the laser element 18 has a circular shape. The laser element 18 is a photonic crystal surface emitting laser (PCSEL) using a photonic crystal effect, for example. The laser light L emitted from the laser element 18 composed of a PCSEL has a small radiation angle and a high light output.

A plurality of the laser elements 18 is provided in one laser element array 14. In the example illustrated in the drawing, the plurality of laser elements 18 is arranged in the Y-axis direction in one laser element array 14. In the laser element arrays 14 adjacent to each other in the X-axis direction, the laser elements 18 are displaced in the Y-axis direction. Specifically, in the laser element arrays 14 adjacent to each other in the X-axis direction, the center of the laser element 18 in one laser element array 14 and the center of the laser element 18 in the other laser element array 14 do not overlap each other in the X-axis direction. In this manner, the irradiation area of the laser light L emitted from the processing head 10 can be increased.

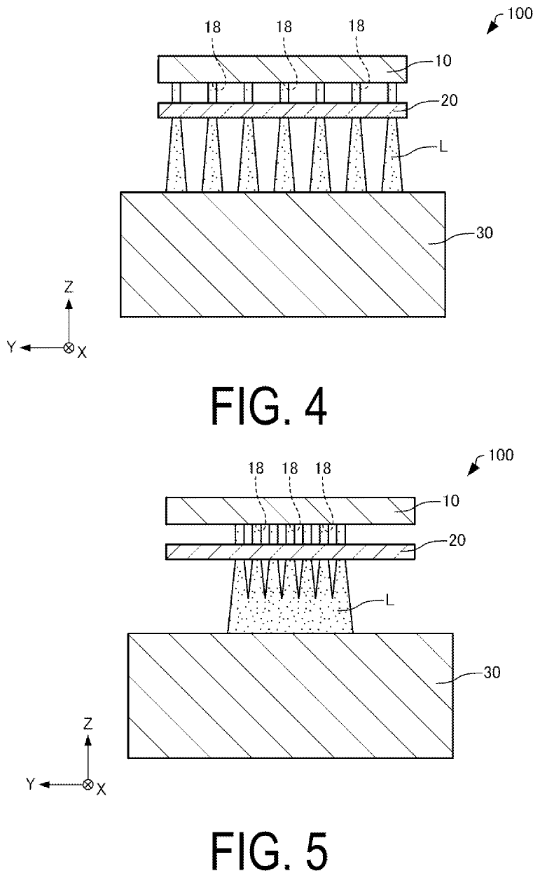

As illustrated in FIG. 1, the laser light L emitted from the laser element 18 enters the first optical element 20. In the example illustrated in the drawing, the first optical element 20 is provided between the processing head 10 and the light receiving element 30. Here, FIG. 4 is a sectional view taken along line IV-IV of FIG. 1 schematically illustrating the laser processing apparatus 100.

As illustrated in FIG. 4, the first optical element 20 is a diffusion element that diffuses the laser light L from the laser element 18. For the first optical element 20, a glass diffusion plate is used, for example. The first optical element 20 causes the laser light L from the laser elements 18 adjacent to each other in the Y-axis direction to enter the light receiving element 30 in a non-superimposed state.

Note that the first optical element 20 may cause the laser light L emitted from the laser elements 18 adjacent to each other in the Y-axis direction to enter the light receiving element 30 in a superimposed state as illustrated in FIG. 5.

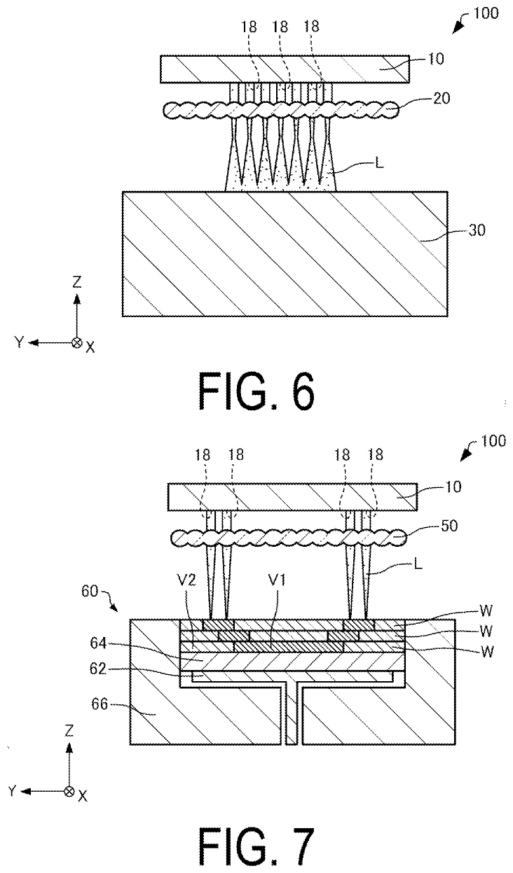

In addition, the first optical element 20 is not limited to the glass diffusion plate as long as the laser light L can be diffused. As illustrated in FIG. 6, the first optical element 20 may be a lens array. In this case, preferably, the focal point of the lens making up the first optical element 20 is not located on the light receiving element 30. In this manner, damage to the light receiving element 30 due to the laser light L can be suppressed. A plurality of the lenses making up the first optical element 20 is provided in a manner corresponding to the number of the laser elements 18.

Light emitted from the first optical element 20 enters the light receiving element 30. The laser light L from the laser element 18 is applied to the light receiving element 30 through the first optical element 20. The light receiving element 30 receives the laser light L and the detects the intensity of the received laser light L. The detection value of the light receiving element 30 is transmitted to the control unit 70 as illustrated in FIG. 1. The light receiving element 30 is a photodiode, for example. The light receiving element 30 is a laser power meter, or a laser energy meter, for example.

Note that the light receiving element 30 may be an imaging element such as a CCD (Charge Coupled Device) image sensor and a CMOS (Complementary Metal Oxide Semiconductor) image sensor. In this case, the light receiving element 30 can detect the two-dimensional intensity distribution of the emission from the plurality of laser elements 18.

As illustrated in FIGS. 1 and 2, the moving mechanism 40 supports the processing head 10. The moving mechanism 40 changes the relative position of the processing head 10 and the stage 60, and the relative position of the processing head 10 and the light receiving element 30. Specifically, the moving mechanism 40 changes the relative position of the laser element 18 and the stage 60, and the relative position of the laser element 18 and the light receiving element 30. In the example illustrated in the drawing, the moving mechanism 40 moves the processing head 10 in the X-axis direction. The moving mechanism 40 has a shape extended in the X-axis direction, for example. The moving mechanism 40 does not move the processing head 10 in the Y-axis direction, for example. The moving mechanism 40 has a configuration including a motor not illustrated in the drawings, for example.

The moving mechanism 40 moves the processing head 10 such that the processing head 10 and the light receiving element 30 face each other as illustrated in FIG. 1, for example. In the example illustrated in the drawing, the processing head 10 and the light receiving element 30 face each other through the first optical element 20. As viewed in the Z-axis direction, the processing head 10 overlaps the light receiving element 30. The first optical element 20 is configured to not move along with the movement of the processing head 10, for example. The first optical element 20 may be fixed with respect to the light receiving element 30.

The moving mechanism 40 moves the processing head 10 to set the state where the processing head 10 and the workpiece W face each other as illustrated in FIG. 2, for example. In the example illustrated in the drawing, the processing head 10 and the workpiece W face each other through the second optical element 50. As viewed from the Z-axis direction, the processing head 10 overlaps the workpiece W. The second optical element 50 is configured to move along with the movement of the processing head 10 in the state where the processing head 10 and the workpiece W face each other, for example. The second optical element 50 does not move along with the movement of the processing head 10 in the state where the processing head 10 and the light receiving element 30 face each other.

The laser light L emitted from the laser element 18 enters the second optical element 50 as illustrated in FIG. 2. In the example illustrated in the drawing, the second optical element 50 is provided between the processing head 10 and the workpiece W. Here, FIG. 7 is a sectional view taken along line VII-VII of FIG. 2 schematically illustrating the laser processing apparatus 100.

As illustrated in FIG. 7, the second optical element 50 focuses the laser light L from the laser element 18, for example. The second optical element 50 is a lens array, for example. Preferably, the focal point of the lens making up the second optical element 50 is located on the workpiece W. In this manner, the processing time of the workpiece W can be shortened. A plurality of the lenses making up the second optical element 50 is provided in a manner corresponding to the number of the laser elements 18.

The workpiece W is supplied and placed on the stage 60. The workpiece W is provided between the processing head 10 and the stage 60. The workpiece W is metal powder that can be melted with the laser light L, for example. The workpiece W is supplied by a supplying machine not illustrated in the drawings.

As illustrated in FIG. 7, the stage 60 includes a base 62, an elevator mechanism 64, and a housing 66 that house the base 62 and the elevator mechanism 64, for example.

The workpiece W is supplied on the base 62. The processing head 10 irradiates the workpiece W on the base 62 with the laser light L to form a molten portion V1 and a non-molten portion V2 in the workpiece W. After molten through irradiation with the laser light L, the molten portion V1 is cooled and solidified. The non-molten portion V2 is not irradiated with the laser light L. Therefore, the non-molten portion V2 is not solidified and remains as metal powder.

The elevator mechanism 64 supports the base 62. In the example illustrated in the drawing, the elevator mechanism 64 moves the base 62 in the −Z-axis direction. The workpiece W is moved along with the movement of the base 62. After the base 62 is moved in the −Z-axis direction, the supplying machine again supplies the workpiece W of the second layer. The workpiece W of the second layer is supplied onto the workpiece W of the first layer. Then, the processing head 10 irradiates the workpiece W of the second layer with the laser light L.

A laminate composed of a plurality of layers of the workpiece W can be formed by repeating the series of steps of the supply of the workpiece W with the supplying machine, the irradiation of the laser light L with the processing head 10, and the movement of the base 62 with the elevator mechanism 64 as described above. Then, a three-dimensional object with a predetermined shape is shaped by removing the non-molten portion V2 of the laminate with a removal apparatus not illustrated in the drawings. Examples of the removal apparatus include an air blow and a brush.

The control unit 70 is composed of a computer including a processor, a main storage apparatus, and an input/output interface for performing input and output of signals with external parts, for example. The control unit 70 implements various functions with the processor executing the program read in the main storage apparatus, for example. More specifically, the control unit 70 controls the laser element 18, the moving mechanism 40, and the elevator mechanism 64. Note that the control unit 70 may be composed of a combination of a plurality of circuits, not the computer.

1.2. Process of Control Unit

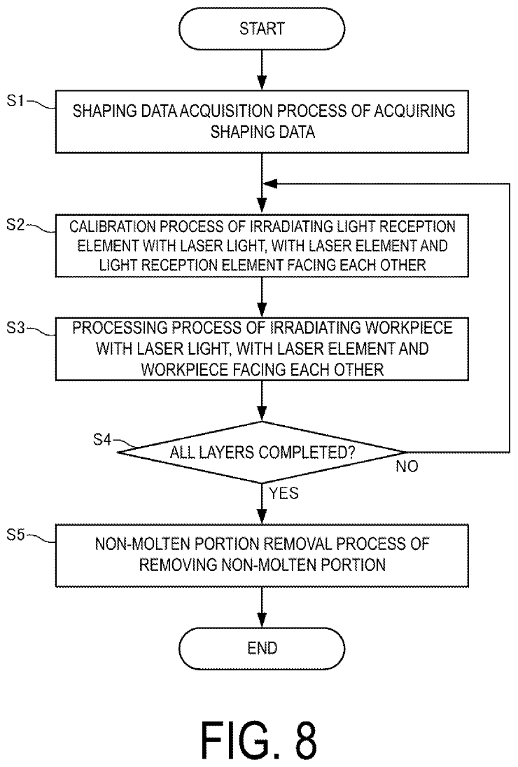

Next, a process of the control unit 70 of the laser processing apparatus 100 according to the embodiment is described with reference to the drawings. FIG. 8 is a flowchart for describing a process of the control unit 70.

The user outputs a process start signal for starting a process to the control unit 70 by operating an operation unit not illustrated in the drawings, for example. The operation unit is composed of a mouse, a keyboard, a touch panel and the like. When the control unit 70 receives the process start signal, it starts the process.

1.2.1. Shaping Data Acquisition Process

First, as illustrated in FIG. 8, the control unit 70 performs a shaping data acquisition process of acquiring shaping data for shaping a three-dimensional object (step S1).

The shaping data includes information relating to the material of the metal powder making up the workpiece W, the number of layers of the workpiece W, the movement speed of the processing head 10, and on/off of the plurality of laser elements 18, for example.

The shaping data is created by reading shape data into slicer software installed in a computer connected to the laser processing apparatus 100, for example. The shape data is data representing an intended shape of a three-dimensional object created by using three-dimensional CAD (Computer Aided Design) software, three-dimensional CG (Computer Graphics) software and/or the like. As the shape data, data of the STL (Standard Triangulated Language) format and/or the AMF (Additive Manufacturing File Format) is used, for example. The slicer software divides the intended shape of the three-dimensional object into layers with a predetermined thickness and creates the shaping data for each layer. The shaping data is represented by G codes and M codes. The control unit 70 acquires the shaping data from the computer connected to the laser processing apparatus 100, and/or a recording medium such as a USB (Universal Serial Bus) memory.

1.2.2. Calibration Process

Next, the control unit 70 controls the laser element 18 and the moving mechanism 40 to perform a calibration process of irradiating the light receiving element 30 with the laser light L in the state where the laser element 18 and the light receiving element 30 face each other as illustrated in FIG. 1 (step S2).

More specifically, the control unit 70 causes the moving mechanism 40 to move the laser element 18 to set the state where the laser element 18 and the light receiving element 30 face each other. Next, the control unit 70 causes the laser element 18 to emit the laser light L. The laser light L from the laser element 18 is applied to the light receiving element 30 through the first optical element 20.

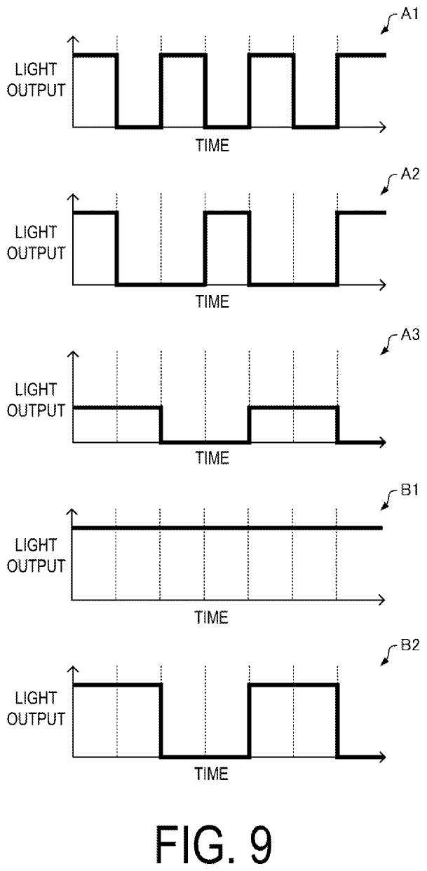

Here, FIG. 9 is a graph illustrating a relationship between the light output and the time at the laser element 18. In FIG. 9, A1, A2 and A3 illustrate relationships in a calibration process. B1 and B2 illustrate relationships in a processing process of processing the workpiece W. Details of the processing process are described later.

The control unit 70 pulse-drives the laser element 18 as illustrated in A1 of FIG. 9 in the calibration process, and CW (Continuous Wave) drives the laser element 18 as illustrated in B1 of FIG. 9 in the processing process. In the example illustrated in the drawing, the light output of the CW-driving is constant.

In the case where the control unit 70 pulse-drives the laser element 18 as illustrated in B2 of FIG. 9 in the processing process, the control unit 70 may pulse-drive the laser element 18 in the calibration process at a frequency higher than the frequency of the pulse-driving of the laser element 18 in the processing process as illustrated in A1 of FIG. 9.

In addition, in the case where the control unit 70 pulse-drives the laser element 18 in the processing process as illustrated in B2 of FIG. 9, the control unit 70 may drive the laser element 18 in the calibration process with a duty ratio smaller than the duty ratio of the laser element 18 in the processing process as illustrated in A2 of FIG. 9.

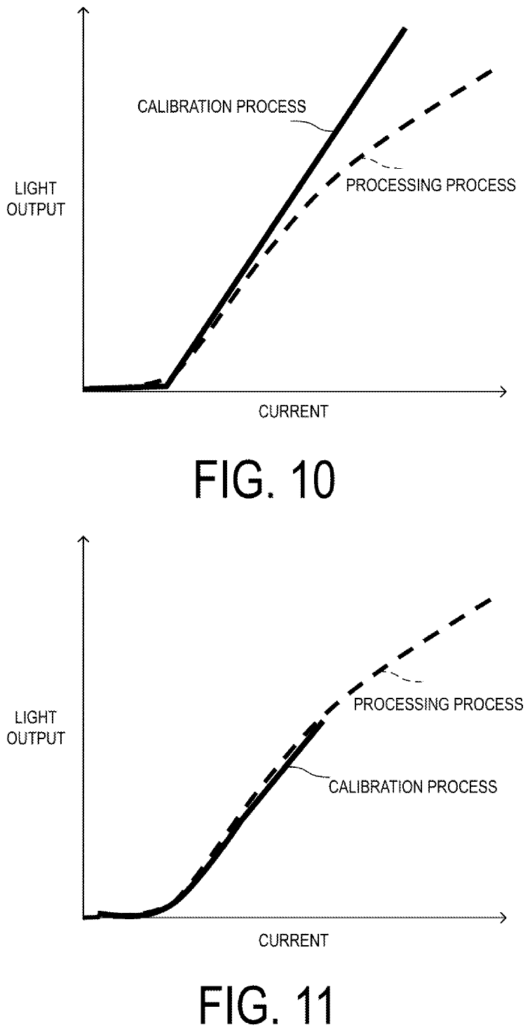

When the laser element 18 is driven as described above, the light output in the calibration process is greater than the light output in the processing process, at a predetermined current value as illustrated in FIG. 10. The reason for this is that in the processing process, a larger current than that of the calibration process is supplied to the laser element 18, resulting in roll-off of the I-L (injection current-light output) characteristics due to the heat.

Note that FIG. 10 is a graph illustrating a relationship between a supplied current and a light output at the laser element 18. The same applies to FIG. 11 described later.

The control unit 70 determines the injection current into the laser element 18 in the processing process based on the detection value of the light receiving element 30. For example, when the detection value of the light receiving element 30 is smaller than a reference value, the control unit 70 sets the injection current into the laser element 18 in the processing process to a value greater than the injection current into the laser element 18 in the calibration process. In this manner, the control unit 70 feeds back the detection value of the light receiving element 30 to the processing process. The calibration process is a process for calibrating the light output of the laser light L in the processing process. Note that the reference value is stored in a storage unit not illustrated in the drawings, for example.

As illustrated in A3 of FIG. 9, the control unit 70 may drive the laser element 18 in the calibration process with a light output smaller than the light output of the laser element 18 in the processing process. In this case, as illustrated in FIG. 11, in the calibration process, the current injected to the laser element 18 is small, and therefore the light output in the high output region is not directly detected. Therefore, the control unit 70 determines the injection current into the laser element 18 in the processing process based on the light output in the low output region of the calibration process.

Note that in the case where a plurality of the laser elements 18 is provided, the number of the laser elements 18 into which the current is injected in the calibration process is smaller than the number of the laser elements 18 into which the current is injected in the processing process. In this manner, damage to the light receiving element 30 due to the laser light L can be suppressed.

1.2.3. Processing Process

Next, by controlling the laser element 18 and the moving mechanism 40, the control unit 70 performs the processing process of irradiating the workpiece W with the laser light L based on the detection value of the light receiving element 30 in the state where the laser element 18 and the workpiece W face each other as illustrated in FIG. 2 (step S3).

More specifically, the control unit 70 causes the moving mechanism 40 to move the laser element 18 to set the state where the laser element 18 and the workpiece W face each other. Next, the control unit 70 causes the laser element 18 to emit the laser light L based on the detection value of the light receiving element 30 and the shaping data. The laser light L from the laser element 18 is applied to the workpiece W through the first optical element 20. In the processing process, the control unit 70 causes the laser element 18 to emit the laser light L while causing the moving mechanism 40 to move the laser element 18 in +the X-axis direction based on the shaping data. In this manner, the workpiece W can be processed. The molten portion V1 and the non-molten portion V2 are formed in the workpiece W as illustrated in FIG. 7.

1.2.4. Determination Process

Next, as illustrated in FIG. 8, the control unit 70 performs a determination process of determining whether the formation of all layers of the workpiece W has been completed based on the shaping data (step S4).

When it is determined that the formation of all layers of the workpiece W has not been completed (at step S4 “NO”), the control unit 70 returns the process to step S2. At step S4, until it is determined that the formation of all layers of the workpiece W has been completed, the control unit 70 repeats steps S2 to S4.

Note that the control unit 70 may return the process to step S3. Then, at step S4, the control unit 70 may repeat steps S3 and S4 until it is determined that the formation of all layers of the workpiece W has been completed.

1.2.5. Non-Molten Portion Removal Process

On the other hand, when the control unit 70 determines that the formation of all layers of the workpiece W has been completed (at step S4 “YES”), the control unit 70 performs the non-molten portion removal process of causing the removal apparatus to remove the non-molten portion V2 of the laminate composed of the workpiece W (step S5). In this manner, a three-dimensional object is shaped. Then, the control unit 70 terminates the process.

Note that the removal of the non-molten portion V2 may be manually performed by the user. In this case, the control unit 70 terminates the process after it is determined that the formation of all layers of the workpiece W has been completed.

1.3. Operational Effect

In the laser processing apparatus 100, the control unit 70 performs the calibration process as a first process of irradiating the light receiving element 30 with the laser light L in the state where the laser element 18 and the light receiving element 30 face each other by controlling the laser element 18 and the moving mechanism 40. Further, the control unit 70 performs the processing process as a second process of irradiating the workpiece W with the laser light L based on the detection value of the light receiving element 30 in the state where the laser element 18 and the workpiece W face each other by controlling the laser element 18 and the moving mechanism 40.

Thus, with the laser processing apparatus 100, even in the case where the characteristics of the laser element 18 are shifted from the designed value, the shift can be detected through the calibration process and fed back to the processing process. In this manner, the workpiece W can be accurately processed through the processing process. In the case where a plurality of the laser elements 18 is provided, the processing can be performed with good uniformity with the plurality of laser elements 18, for example.

Further, the laser processing apparatus 100 irradiates the light receiving element 30 with the laser light L in the state where the laser element 18 and the light receiving element 30 face each other. Thus, damage to the light path changing element due to the laser light L can be suppressed in comparison with the case where the light path of the laser light L from the laser element to the workpiece W is changed by using a light path changing element such as a mirror and a beam splitter to irradiate the light receiving element with the laser light L, for example. If the light path changing element is damaged, the laser light L may not possibly be guided to the light receiving element. In particular, in the case where the laser element is a PCSEL, the light path changing element is easily damaged if the light path changing element is used because the radiation angle is narrow.

The laser processing apparatus 100 includes the first optical element 20 as a diffusion element that diffuses the laser light L from the laser element 18, and the laser light L from the laser element 18 is applied to the light receiving element 30 through the first optical element 20. Thus, the laser processing apparatus 100 can achieve a low density of the laser light L entering the light receiving element 30. In this manner, damage to the light receiving element 30 can be suppressed.

In the laser processing apparatus 100, the control unit 70 pulse-drives the laser element 18 in the calibration process, and CW-drives the laser element 18 in the processing process. Thus, the laser processing apparatus 100 can suppress damage to the light receiving element 30 in the calibration process.

In the laser processing apparatus 100, in the calibration process, the control unit 70 pulse-drives the laser element 18 at a frequency higher than the frequency of the pulse-driving of the laser element 18 in the processing process. Thus, the laser processing apparatus 100 can suppress damage to the light receiving element 30 in the calibration process.

In the laser processing apparatus 100, the control unit 70 drives the laser element 18 in the calibration process at a duty cycle smaller than the duty cycle of the laser element 18 in the processing process. Thus, the laser processing apparatus can suppress damage to the light receiving element 30 in the calibration process.

In the laser processing apparatus 100, the control unit 70 drives the laser element 18 in the calibration process at a light output smaller than the light output of the laser element 18 in the processing process. Thus, the laser processing apparatus 100 can suppress damage to the light receiving element 30 in the calibration process.

In the laser processing apparatus 100, the laser element 18 is a PCSEL. Thus, the laser processing apparatus 100 can achieve a small radiation angle of the laser light L from the laser element 18. In this manner, the processing time of the workpiece W can be shortened.

2. Modifications of Laser Processing Apparatus

2.1. First Modification

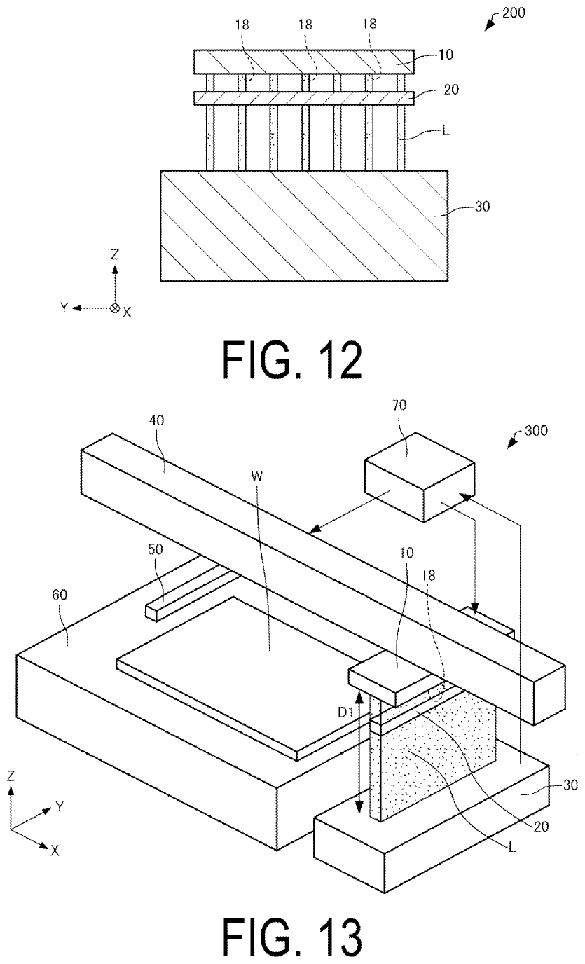

Next, a laser processing apparatus according to a first modification of the embodiment is described with reference to the drawings. FIG. 12 is a sectional view schematically illustrating a laser processing apparatus 200 according to the first modification of the embodiment.

In the following description, in the laser processing apparatus 200 according to the first modification of the embodiment, the components with the same functions as those of the above-described laser processing apparatus 100 according to the embodiment are denoted with the same reference numerals, and the description thereof is omitted. The same applies to a laser processing apparatus according to a second modification of the embodiment described later.

In the above-described laser processing apparatus 100, the first optical element 20 is a diffusion element that diffuses the laser light L from the laser element 18 as illustrated in FIG. 4.

In the laser processing apparatus 200, the first optical element 20 is a light reduction element that reduces the laser light L from the laser element 18 as illustrated in FIG. 12. The first optical element 20 does not diffuse the laser light L from the laser element 18. The light reduction element is a light reduction filter, for example.

In the laser processing apparatus 200, the first optical element 20 is a light reduction element that reduces the laser light L from the laser element 18. Thus, the laser processing apparatus 200 can achieve a low intensity of the laser light L that enters the light receiving element 30. In this manner, damage to the light receiving element 30 can be suppressed.

2.2. Second Modification

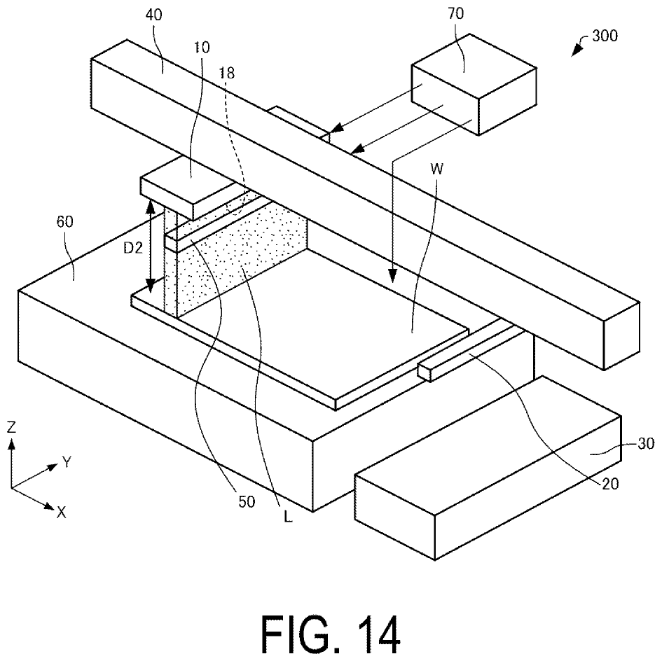

Next, a laser processing apparatus according to a second modification of the embodiment is described with reference to the drawings. FIGS. 13 and 14 are perspective views schematically illustrating a laser processing apparatus 300 according to the second modification of the embodiment. FIG. 13 illustrates a state of the calibration process. FIG. 14 illustrates a state of the processing process.

As illustrated in FIGS. 13 and 14, the laser processing apparatus 300 differs from the above-described laser processing apparatus 100 in that a distance D1 between the laser element 18 and the light receiving element 30 in the calibration process is greater than a distance D2 between the laser element 18 and the workpiece W in the processing process.

In the example illustrated in the drawing, the distance D1 is the distance between the laser element 18 and the light receiving element 30 in the Z-axis direction in the calibration process. The distance D2 is the distance between the laser element 18 and the workpiece W in the Z-axis direction in the processing process.

In the laser processing apparatus 300, the distance D1 between the laser element 18 and the light receiving element 30 in the calibration process is greater than the distance D2 between the laser element 18 and the workpiece W in the processing process. Thus, the laser processing apparatus 300 can achieve a smaller intensity of the laser light L that enters the light receiving element 30 in comparison with the case where the distance D1 is smaller than the distance D2. In this manner, damage to the light receiving element 30 can be suppressed.

The embodiments and variations described above are examples, and are not limitative. For example, each embodiment and each variation can be combined as appropriate.

The present disclosure includes configurations substantially identical to the configurations described in the embodiments, e.g., configurations with identical functions, methods and results, or with identical purposes and effects. The present disclosure also includes configurations in which non-essential parts of the configurations described in the embodiments are replaced. The present disclosure also includes configurations that have the same operational effect or can achieve the same purpose as the configurations described in the embodiments. The present disclosure also includes a configuration in which a known technology is added to the configuration described in the embodiments.

The following contents can be derived from the embodiments and variations described above.

A laser processing apparatus according to one aspect includes a stage on which a workpiece is placed, a laser element configured to emit laser light, a light receiving element configured to receive the laser light from the laser element, a moving mechanism configured to change a relative position of the laser element and the stage and a relative position of the laser element and the light receiving element, and a control unit configured to control the laser element and the moving mechanism. The control unit performs a first process of controlling the laser element and the moving mechanism to irradiate the light receiving element with laser light in a state where the laser element and the light receiving element face each other, and a second process of controlling the laser element and the moving mechanism to irradiate the workpiece with laser light based on a detection value of the light receiving element in a state where the laser element and the workpiece face each other.

With this laser processing apparatus, the workpiece can be accurately processed.

The laser processing apparatus according to the aspect may further include a diffusion element configured to diffuse the laser light from the laser element. The laser light from the laser element may be applied to the light receiving element through the diffusion element.

With this laser processing apparatus, damage to light receiving element can be suppressed.

The laser processing apparatus according to the aspect may further include a light reduction element configured to reduce the laser light from the laser element. The laser light from the laser element may be applied to the light receiving element through the light reduction element.

With this laser processing apparatus, damage to light receiving element can be suppressed.

In the laser processing apparatus according to the aspect, a distance between the laser element and the light receiving element in the first process may be greater than a distance between the laser element and the workpiece in the second process.

With this laser processing apparatus, damage to light receiving element can be suppressed.

In the laser processing apparatus according to the aspect, the control unit may pulse-drive the laser element in the first process, and CW-drive the laser element in the second process.

With this laser processing apparatus, damage to light receiving element can be suppressed.

In the laser processing apparatus according to the aspect, in the first process, the control unit may pulse-drive the laser element at a frequency higher than a frequency of pulse-driving of the laser element in the second process.

With this laser processing apparatus, damage to light receiving element can be suppressed.

In the laser processing apparatus according to the aspect, in the first process, the control unit may drive the laser element at a duty cycle smaller than a duty cycle of the laser element in the second process.

With this laser processing apparatus, damage to light receiving element can be suppressed.

In the laser processing apparatus according to the aspect, in the first process, the control unit may drive the laser element at a light output smaller than a light output of the laser element in the second process.

With this laser processing apparatus, damage to light receiving element can be suppressed.

In the laser processing apparatus according to the aspect, the laser element may be a photonic crystal surface emitting laser.

With this laser processing apparatus, the radiation angle of the laser light from laser element can be reduced.

What is claimed is:

1. A laser processing apparatus comprising:
a stage on which a workpiece is placed;
a laser element configured to emit laser light;
a light receiving element configured to receive the laser light from the laser element;
a moving mechanism configured to change a relative position of the laser element and the stage and a relative position of the laser element and the light receiving element; and
a control unit configured to control the laser element and the moving mechanism, wherein
the control unit performs
a first process of controlling the laser element and the moving mechanism to irradiate the light receiving element with laser light in a state where the laser element and the light receiving element face each other, and
a second process of controlling the laser element and the moving mechanism to irradiate the workpiece with laser light based on a detection value of the light receiving element in a state where the laser element and the workpiece face each other.

2. The laser processing apparatus according to claim 1, further comprising a diffusion element configured to diffuse the laser light from the laser element, wherein
the laser light from the laser element is applied to the light receiving element through the diffusion element.

3. The laser processing apparatus according to claim 1, further comprising a light reduction element configured to reduce the laser light from the laser element, wherein
the laser light from the laser element is applied to the light receiving element through the light reduction element.

4. The laser processing apparatus according to claim 1, wherein a distance between the laser element and the light receiving element in the first process is greater than a distance between the laser element and the workpiece in the second process.

5. The laser processing apparatus according to claim 1, wherein the control unit pulse-drives the laser element in the first process, and CW-drives the laser element in the second process.

6. The laser processing apparatus according to claim 1, wherein in the first process, the control unit pulse-drives the laser element at a frequency higher than a frequency of pulse-driving of the laser element in the second process.

7. The laser processing apparatus according to claim 1, wherein in the first process, the control unit drives the laser element at a duty cycle smaller than a duty cycle of the laser element in the second process.

8. The laser processing apparatus according to claim 1, wherein in the first process, the control unit drives the laser element at a light output smaller than a light output of the laser element in the second process.

9. The laser processing apparatus according to claim 1, wherein the laser element is a photonic crystal surface emitting laser.
